(19) United States
(12) Patent Application Publication
(10) Pub. No.: US 2015/0067070 A1
(43) Pub. Date: Mar. 5, 2015

(54) SYSTEM AND METHOD FOR PERFORMING GENDER BALANCING OF AN EVENT USING NOTIFICATIONS IN A NETWORK ENVIRONMENT

(71) Applicant: MATCH.COM, L.L.C., Dallas, TX (US)

(72) Inventors: Thomas Edward Jacques, Long Island City, NY (US); Michael George Maxim, Bronx, NY (US); Tom R. Quisel, New York, NY (US)

(73) Assignee: MATCH.COM, L.L.C., Dallas, TX (US)

(21) Appl. No.: 14/012,148

(22) Filed: Aug. 28, 2013

(51) Int. Cl. H04L 12/58; G06F 17/30

(52) U.S. Cl. CPC H04L 51/00; G06F 17/30861
USPC 709/206; 707/736

(57) ABSTRACT

A method is provided in one example embodiment and includes determining a first number of users who have indicated an intention to attend an event; determining what fraction of the first number of users is a particular gender; and using the determined fraction and an ideal fraction of the particular gender for the event to determine an additional number of males or an additional number of females to be invited to attend the event.

### RELATED APPLICATIONS

This application is related to U.S. patent application Ser. No. 13/967,983, filed Aug. 15, 2013, entitled “SYSTEM AND METHOD FOR OPTIMIZING PROMOTION OF A SOCIAL EVENT IN A NETWORK ENVIRONMENT” (Attorney Docket No. 76533.0313), the disclosure of which is considered part of and incorporated by reference in the disclosure of this application.

### TECHNICAL FIELD

This disclosure relates in general to the field of communications and, more particularly, to a system and a method for performing gender balancing of an event using notifications in a network environment.

### BACKGROUND

Communications network architectures have experienced significant notoriety because they can offer the benefits of automation, convenience, and data management for their respective online communities. Certain network protocols may be used in order to allow an end user to be matched to other end users or to scenarios in which they stand to benefit (e.g., job searches, person-finding services, real estate searches, online dating, etc.).

In the case of an online dating service, for example, an end user will typically be prompted to specify a variety of preferences to be used in matching the end user with other end users in a particular online dating community. The information each end user provides about him or herself may be viewed by other end users in the online community in determining whether to interact with that end user. In certain cases, the actual dating platform can participate in matching activities. This interventionist involvement can often spur or provoke new relationships being formed.

### BRIEF DESCRIPTION OF THE DRAWINGS

To provide a more complete understanding of the present disclosure and features and advantages thereof, reference is made to the following description, taken in conjunction with the accompanying figures, wherein like reference numerals represent like parts, in which:

FIG. 1 is a network diagram showing an operating environment of the present disclosure in accordance with one embodiment of the present disclosure;

FIGS. 2A-J are simplified screen shots of an example protocol for participating in an on-line dating service in accordance with one embodiment of the present disclosure; and

FIG. 3 is a flow diagram illustrating logic implemented by an event notification feature of an on-line dating service, such as illustrated in FIGS. 1-2J, in accordance with one embodiment of the present disclosure.

### DETAILED DESCRIPTION OF EXAMPLE EMBODIMENTS

### Overview

A method is provided in one example embodiment and includes determining a first number of users who have indicated an intention to attend an event. The indication to attend could be in the form of an electronic signal, an email, a verbal commitment, a simple online enrollment, a checked box, a default attendance based on a previously indicated preference, etc. The method also includes determining what fraction of the first number of users is a particular gender (e.g., a percentage, a raw number, a number as contrasted with the opposite sex, etc.); and using the determined fraction and an ideal fraction of the particular gender for the event to determine an additional number of males or an additional number of females to be invited to attend the event. In certain embodiments, the method could further include identifying from a pool of users additional males or additional females (e.g., identifying a subscriber(s), a profile(s), a member(s) of an online community, etc.). The term “event” can include any type of social gathering between two individuals, or a group of individuals (e.g., a cooking class, a movie showing, a sports event, a concert, a day at a public park, a museum outing, a coffee date, a festival, a dance, a dinner date, a political debate, etc.). The term “pool” can include any type of plurality, any type of subset, any type of grouping, etc. The method can also include inviting the identified additional females or additional males to the event.

In some embodiments, the inviting comprises sending an email comprising an invitation to the event to the identified males and females. In other embodiments, the inviting comprises displaying information concerning the event to the identified males and females. The identifying may comprise identifying users from the pool of users whose profile attributes or event invitation history indicate a likelihood that they will accept an invitation to attend the event. The identifying may further comprise identifying users from the pool of users that share similar profile attributes with the first number of users. In at least one embodiment, using the determined fraction and an ideal fraction of the particular gender for the event to determine an additional number of males and an additional number of females to be invited to attend the event comprises using a balance multiplier to control how strongly an imbalance in a male-to-female ratio of the first number is reacted to.

### Example Embodiments

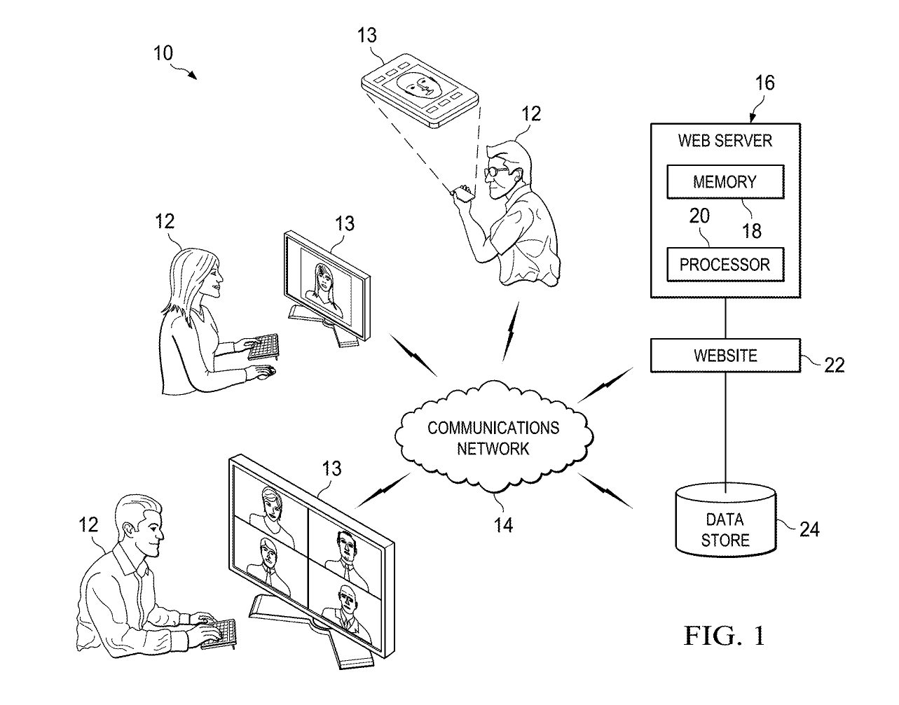

FIG. 1 is a simplified block diagram of a system 10 for facilitating an online dating scenario in a network environment. In other embodiments in which communications or matching is valuable, system 10 can be leveraged to identify and to evaluate suitable candidates in other areas (e.g., hiring/employment, recruiting, real estate, general person searches, etc.). FIG. 1 includes multiple end users 12 and endpoints 13, a communications network 14, a web server 16 comprising memory 18 and a at least one processor 20, a website 22, and a data store 24. Data store 24 may be any type of mechanism for storing data, including but not limited to one or more files, databases, memory devices, mass storage devices, data centers, etc. System 10, users 12 interact with web server 16 via endpoints 13, each of which comprises an appropriate user interface for interacting with web server 16 via website 22 for facilitating functions and features described herein. In certain example implementations, website 22 and web server 16 are consolidated into a single component, physical structure, equipment, etc.

FIG. 1 may be configured such that inter- and intra-communications are readily achieved by any of the components included therein. The present disclosure is capable of providing both an online component (as illustrated in FIG. 1) and an off-line component such that one or more end users can meet, gather information, resolve to meet, and then subsequently meet in person with the assistance of system 10. Ancillary components to such a comprehensive process may involve pre-date profiles, post-date follow-ups, and a myriad of other significant features, some of which are outlined in detail below.

End users 12 may include a variety of types of end users, such as clients, customers, prospective customers, or entities wishing to participate in an online dating scenario and/or to view information associated with other participants in the system. End users 12 may also seek to access or to initiate communications with other end users that may be delivered via communications network 14. End users 12 may review data (such as user profiles, for example) associated with other users in order to make matching decisions or selections. Data, as used herein in this document, refers to any type of numeric, voice, video, or script data, or any other suitable information in any appropriate format that may be communicated from one point to another.

End users 12 may access the aforementioned data via endpoints 13, which may be inclusive of devices used to initiate a communication. Note that the broad term “user” encompasses any type of node or user device, or any type of endpoint discussed herein. Additionally, the term “user” can further include any type of profile to be used in the system discussed herein. Hence, the term “user” can include (but is not limited to) elements such as a computer, a personal digital assistant (PDA), a laptop or electronic notebook, a cellular telephone, an IP telephone, an iPhone™, an iPad™, a Microsoft Surface™, an Android™ phone, a Google Nexus™, or any other device, component, element, or object capable of initiating voice, audio, or data exchanges within communication system 10. The endpoints may be inclusive of a suitable interface to the end user 12, such as a microphone, a display, or a keyboard or other terminal equipment. Endpoints 13 may also include any device that seeks to initiate a communication on behalf of another entity or element, such as a program, a database, or any other component, device, element, or object capable of initiating a voice or a data exchange within communication system 10. In addition, each of the endpoints 13 may be a unique element designed specifically for communications involving system 10. Such an element may be fabricated or produced specifically for matching applications involving end user 12 and endpoint 13.

A user may employ any device capable of operating as an endpoint 13 to connect to communications network 14 via wire, wireless, cellular, satellite link or other suitable interfaces. Web server 16, which as previously noted includes memory 18 and at least one processor 20, hosts website 22 and has access to transmit and receive user or presence data (e.g., user profile data, user and/or user endpoint data, user contact data) from database 24. Presence data may be collected, aggregated, and utilized as required to facilitate communications between endpoints 12 over communications network 10 or other outside communication systems. Presence data may also include information and/or instructions enabling the creation, duration, and termination of communication sessions between diverse endpoints 13 that utilize different communication and/or networking protocols.

Communications network 14 is a communicative platform operable to exchange data or information emanating from endpoints 13. Communications network 14 represents an Internet architecture in a particular embodiment of the present disclosure, which provides end users 12 with the ability to electronically execute or to initiate actions associated with finding a potential match candidate. Alternatively, communications network 14 could be a plain old telephone system (POTS), which end user 12 could use to perform the same operations or functions. Such transactions may be assisted by management associated with website 22 or manually keyed into a telephone or other suitable electronic equipment. In other embodiments, communications network 14 could be any packet data network (PDN) offering a communications interface or exchange between any two nodes in system 10. Communications network 14 may alternatively be any local area network (LAN), metropolitan area network (MAN), wide area network (WAN), wireless local area network (WLAN), virtual private network (VPN), intranet, or any other appropriate architecture or system that facilitates communications in a network or telephonic environment.

In one embodiment, web server 16 comprises a server that is operable to receive and to communicate information to one or more end users 12. In a generic sense, web server 16 can implement a computer-implemented matching system that provides a framework for suitable matching activities. Alternatively, web server 16 may be any switch, router, gateway, cache, server blade, software, processor, proprietary component, object, module, or element (or any combination of these) operable to facilitate communications involving end user 12. Web server 16 may be integrated with database 24 and/or website 22, where any one or more of these elements may share or otherwise coordinate the activities discussed herein.

In one particular embodiment, web server 16, via interaction with database 24 and/or in conjunction with website 22, is engaged in facilitating interaction(s) between parties interested in seeking a romantic partner (i.e., online dating). For example, website 22 can be online dating service provider www.Match.com, www.Chemistry.com, or any other suitable provider. In certain example scenarios, a given end user may pay a fee for a subscription-based service (and potentially, only those users would qualify to be eligible to participate in events in certain example implementations, although other example embodiments involve non-members being eligible for participation). Additionally, certain end user fee structures may apply to different tiers of service: some of which may entitle an end user to enhanced features on website 22 (e.g., the ability to communicate more frequently with other users, additional matches being provided (potentially, more frequently) to an end user who paid the higher fee structure, the ability to store data, the ability to share data, the ability to upload additional information, the ability to target specific searches based on particular criteria, the ability to receive preferential positioning in the context of being matched to other users, the ability to perform video calls (e.g., Skype, etc.) with other users, the ability to perform audio calls with other users, etc.).

In certain embodiments, website 22 is a computer-implemented matching system, which may be any website or architecture provided for facilitating a connection involving two or more people, and which may make use of a given profile, photograph, resume, article description, etc. This could include services associated with job placements, escort services, auction services, social media, real estate listings, recruiting services (e.g., in athletics, academia, employment scenarios, instances involving the sales of goods and services), etc.

Considerable flexibility is provided by the structure of web server 16 and website 22 in the context of system 10. Thus, it can be easily appreciated that such functions could be provided external to web server 16 or website 22. In such cases, such a functionality could be readily embodied in a separate component, server, processor, device, or module. Note that these online dating features and capabilities may be provided in just one of these elements, in both, or distributed across both of them. Hence, in certain embodiments, the online dating operations may be consolidated in a single website, where no redirection is needed, nor performed for the user.

In operation of an example embodiment, consider a case where a given end user is interested in participating in an online dating scenario. End user 12 can access website 22 via the communications network 14 (which in the example presented comprises the Internet) using endpoint 13, register, and create a profile on the site. Moreover, end user 12 can access website 22 through any suitable banner, pop-up, partnership, e-mail solicitations, direct mailings, etc. It can be appreciated that online commerce can be generated by a plethora of marketing tools and any such tools can readily cooperate with the operations of the present disclosure.

At this point, matching of any form can commence amongst the members of the online community. For example, in the context of a romantic endeavor, a person may begin the dating process or engage in communications that would spawn such dating. Other applications could include job applicants who are being sought by employers. Any of the individuals who reside in the online community can begin using any of the tools or capabilities of the platform.

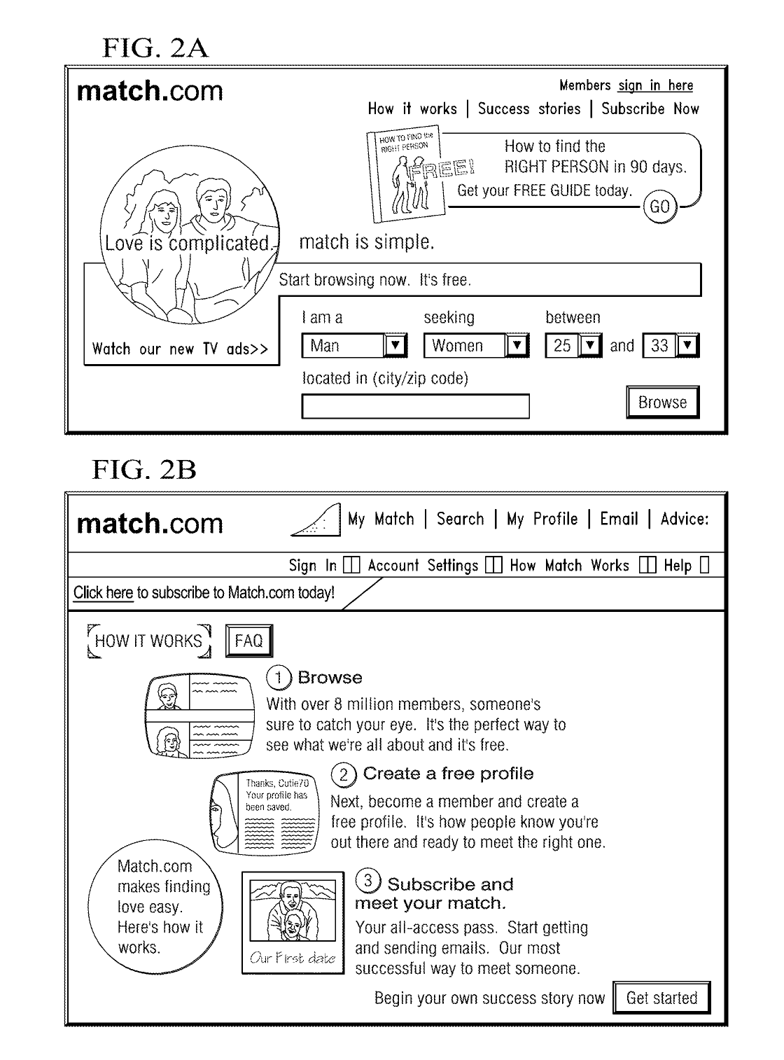

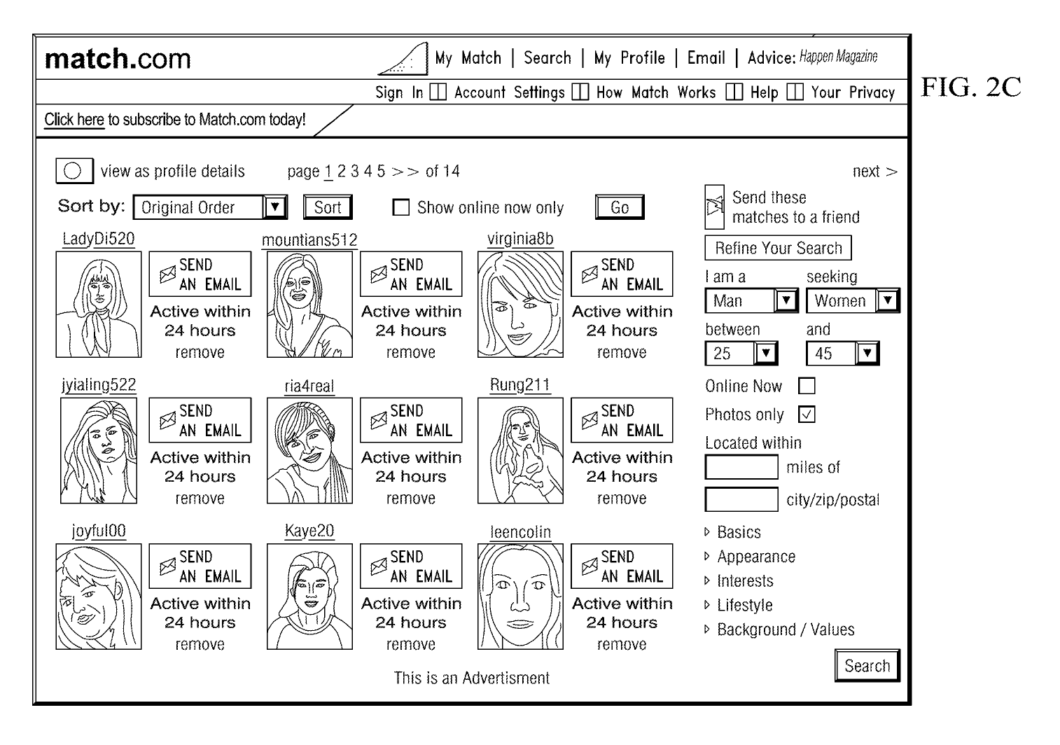

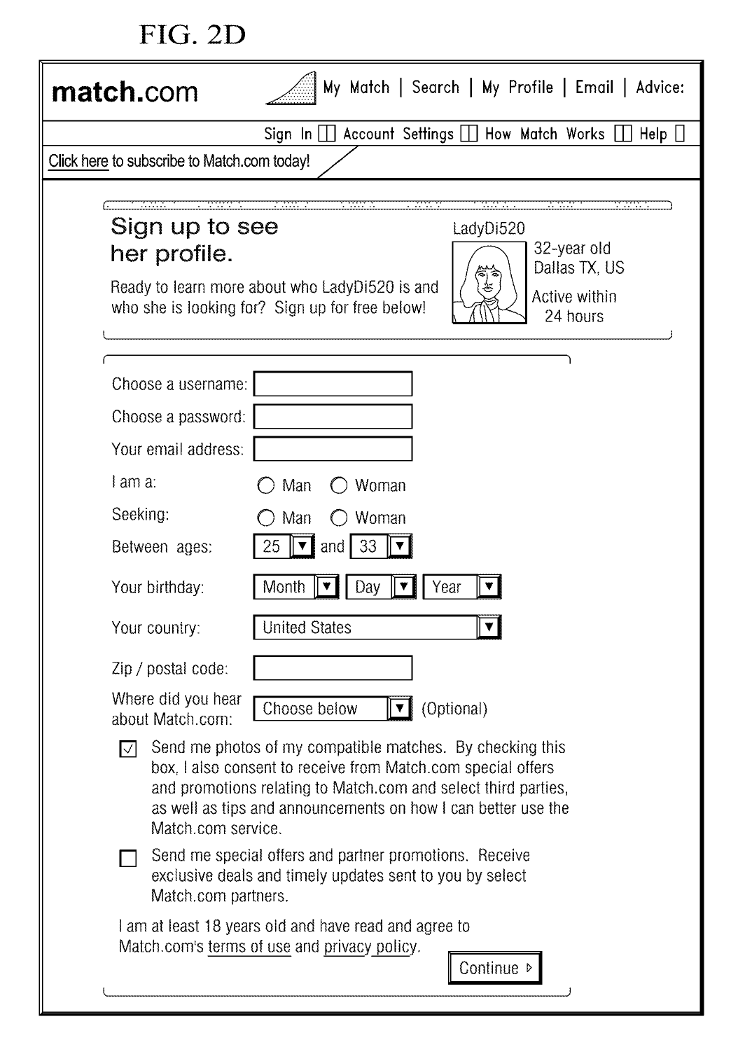

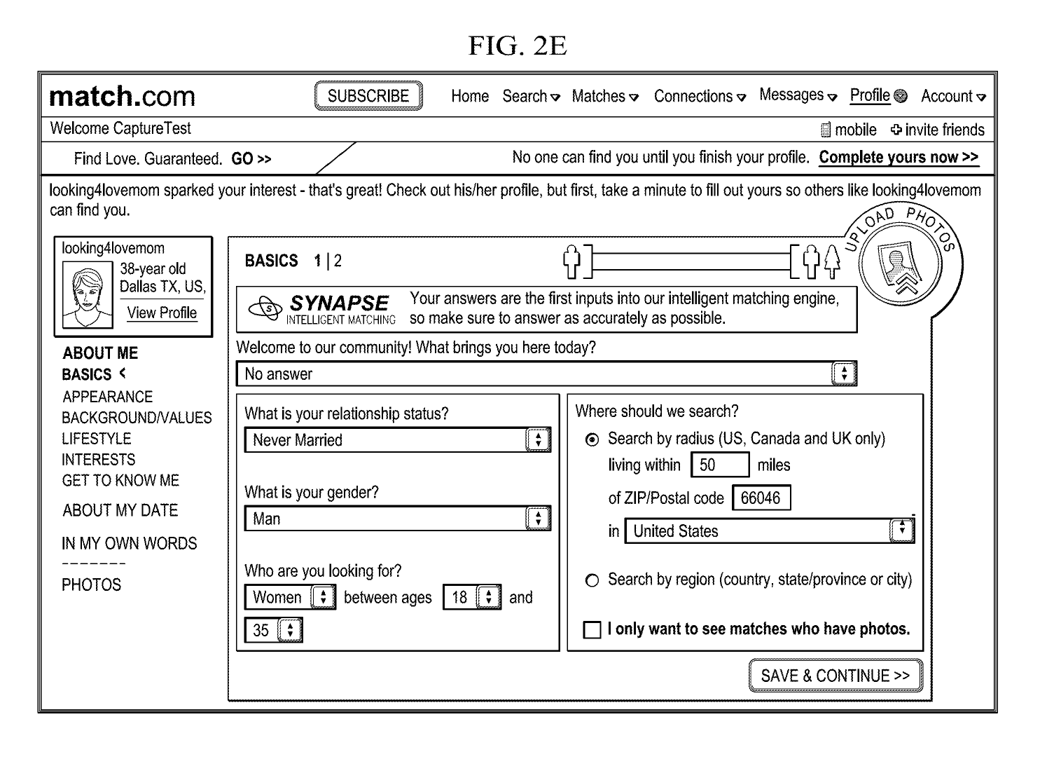

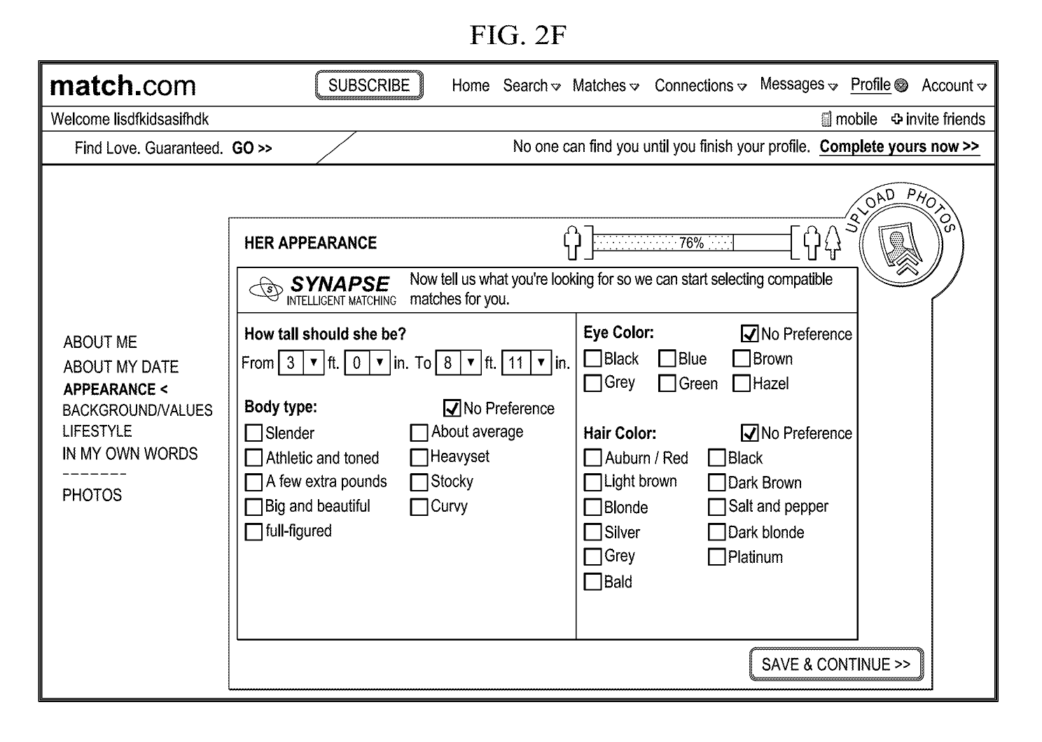

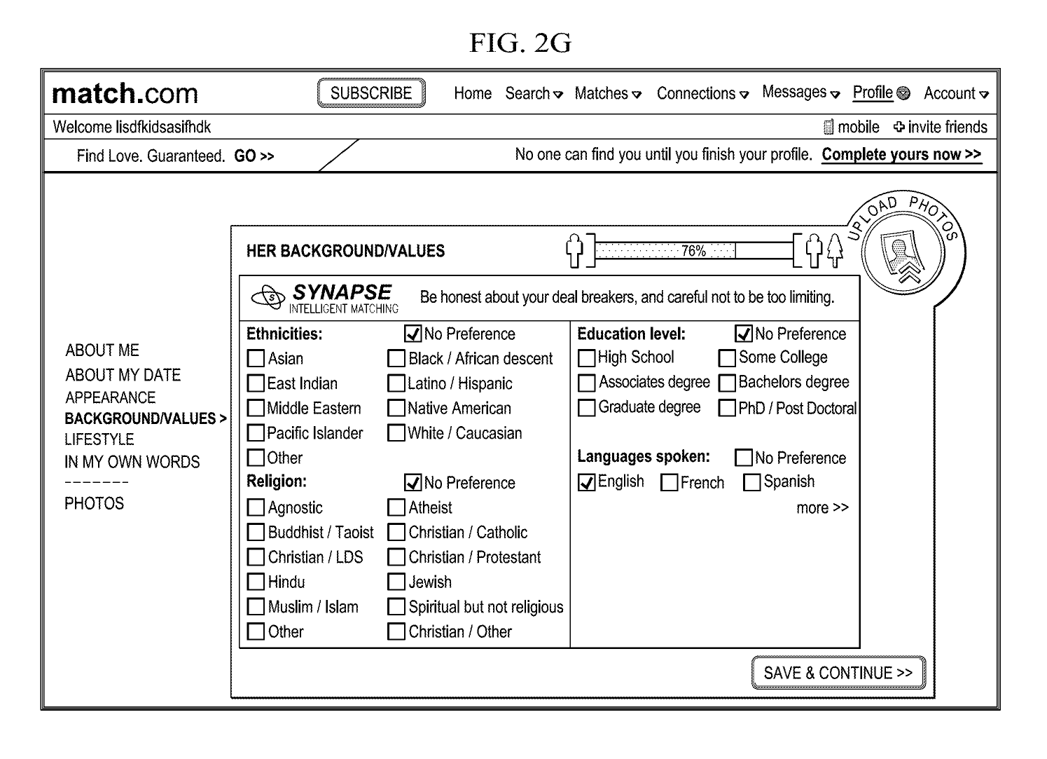

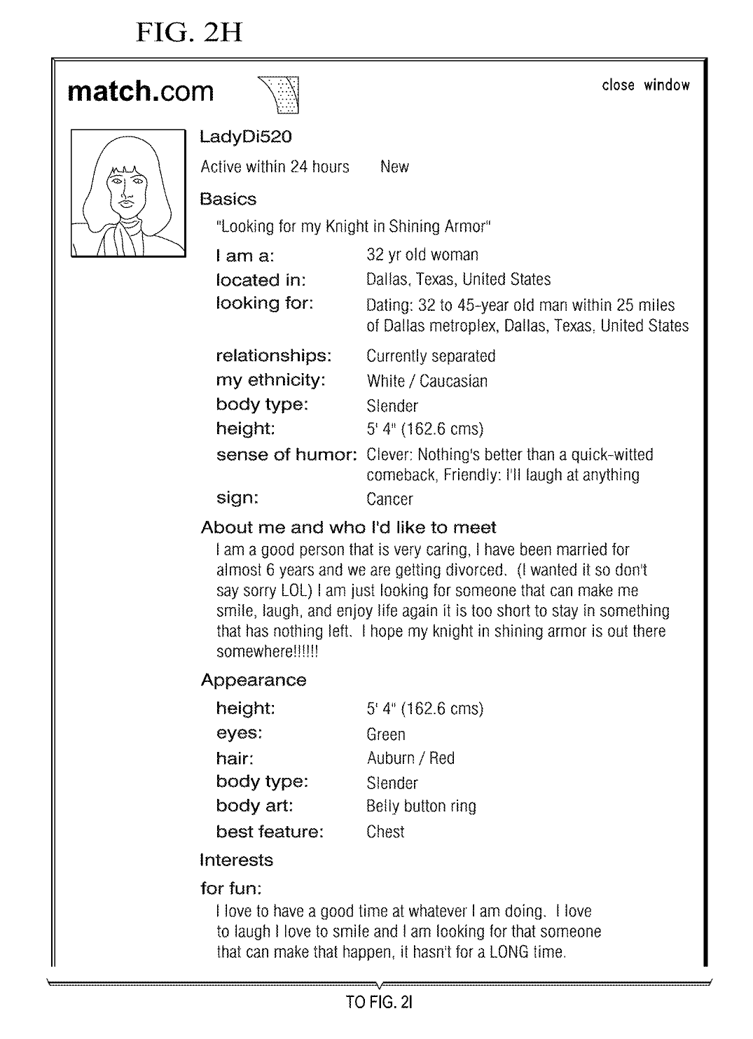

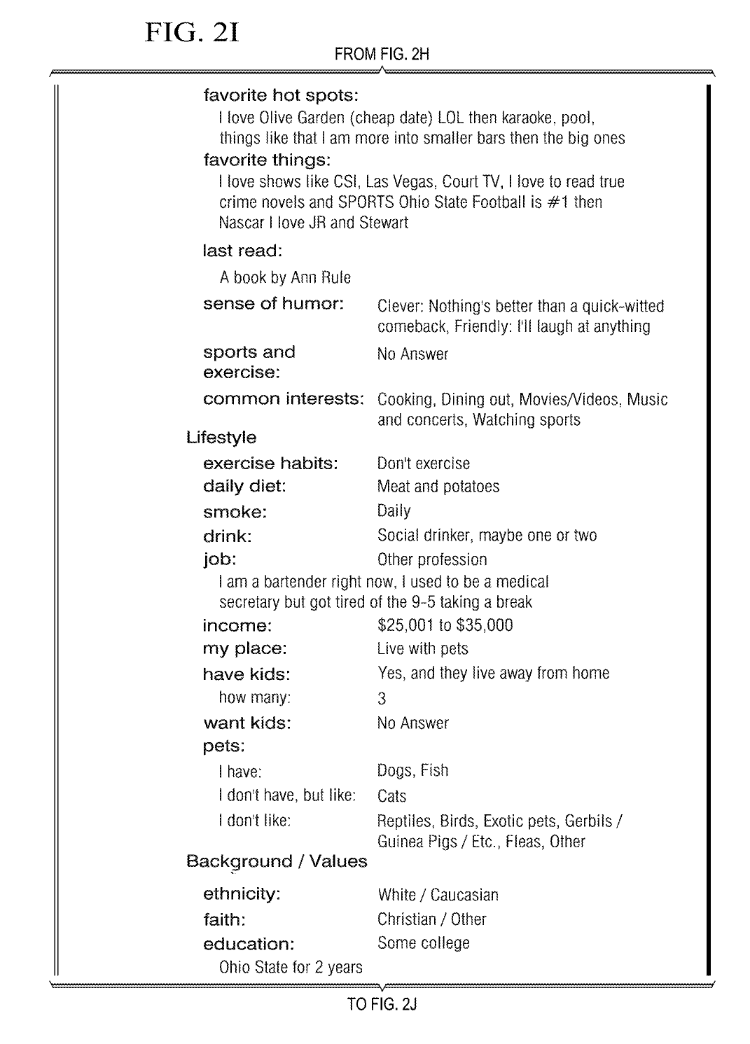

FIGS. 2A-2J illustrate example screen shots that may be provided in the online dating process to facilitate presentation of information to and gathering of information from member end users. FIGS. 2A-2J are presented herein for purposes of discussion. It is imperative to note that these illustrations are only being provided to further outline a particular implementation of the present disclosure. In no way should these diagrams be used to limit or to restrict the broad teachings of the present disclosure. Such illustrative information has been offered earnestly and, thus, should not be construed to confine the broad applications of the present disclosure.

FIG. 2A is an example screen shot of a home page from which an interested end user may begin his/her journey. In the illustrated example, the home page solicits location information, such as a city or zip code, as well as an indication of the end user's gender and an age range and gender preference of persons the end user is interested in “meeting” via system 10. Subsequent to the end user's completion of the requested information and clicking on a “How it Works” icon on the home page of FIG. 2A, a screen shot as shown in FIG. 2B is presented to the end user. The screen shot of FIG. 2B provides a generic outline of the online dating process. As outlined in the screen shot of FIG. 2B, as a first step, an end user may choose to browse the website to view pictures of members along with summaries of the members' profiles. After browsing the website, the end user may decide to create a free profile. Once the end user browses the website and creates a profile, the end user may opt to subscribe to the service and receive information from/about others who are part of the online community. For purposes of example and ease of explanation, it will be assumed for the remainder of the discussion of FIGS. 2A-2D that the potential new end user investigating and ultimately subscribing to the service is a male named “Tom” who is interested in finding a female match.

FIG. 2C is an example screen shot of a number of profiles that may be viewed by Tom during the browsing phase described above. In the context of this shot, Tom may be simply browsing. Assuming Tom has decided he would like to know more about one of the members whose profile is presented in FIG. 2C, he may click on the picture associated with the selected profile. For example, assuming Tom has decided he would like more information about “LadyDi520”, clicking on her picture results in his being directed to a web page as shown in FIG. 2D, where he is solicited to sign up for the online dating subscription such that he can effectively contact his candidate selection. It will be noted that the information solicited using the page shown in FIG. 2C may be used in selecting matches for Tom. The information may also be displayed on Tom's profile or summary thereof presented to other users to assist those users in determining whether they are interested in interacting with him.

FIGS. 2E-2G illustrate various screen shots comprising a user information collection process in accordance with one embodiment. Using the web pages illustrated in FIGS. 2E-2G, system 10 collects a variety of information from an end user, including, but not limited to, basic information about the end user (FIG. 2E), as well as information about the type person the end user would be interested in dating, including information about a potential date's physical appearance (FIG. 2F) and background and values (FIG. 2G). It will be recognized that the information collected using the web pages illustrated in FIGS. 2E-2G is illustrative only and that any type/amount of information may be solicited in the illustrated manner.

FIGS. 2H-2J are example screen shots of the full profile of LadyDi520, the picture Tom selected while browsing. In illustrated profile, LadyDi520's match criteria are displayed, as well as other information that may be pertinent to a potential mate. Any suitable items can be provided in such a profile (such as interests, favorite hot spots, favorite things, desire for children, background, etc.). Virtually any type or format of information (inclusive of video and audio data) may be provided in such a profile. In particular, the profile includes information that was solicited from LadyDi520 when she set up her online dating account. The profile may include a photo, biographical information (e.g., gender, age, location, relationship status, etc.), physical information (e.g., height, weight, hair and eye color, etc.), interests (e.g., hobbies, “favorites,” etc.), lifestyle information (e.g., exercise habits, employment, smoking/drinking habits, etc.), and background/values (e.g., ethnicity, faith, education, etc.). The profile may also include a section entitled “About My Date,” in which the end user specifies preferences about the type of person he/she would like to meet/date (e.g., appearance, interests, faith, education, relationship goals, etc.). In some embodiments, a full profile, including the profile information provided by the end user and stored in the system, is displayed to interested viewers; in other embodiments, only a summary or subset of the profile information is displayed.

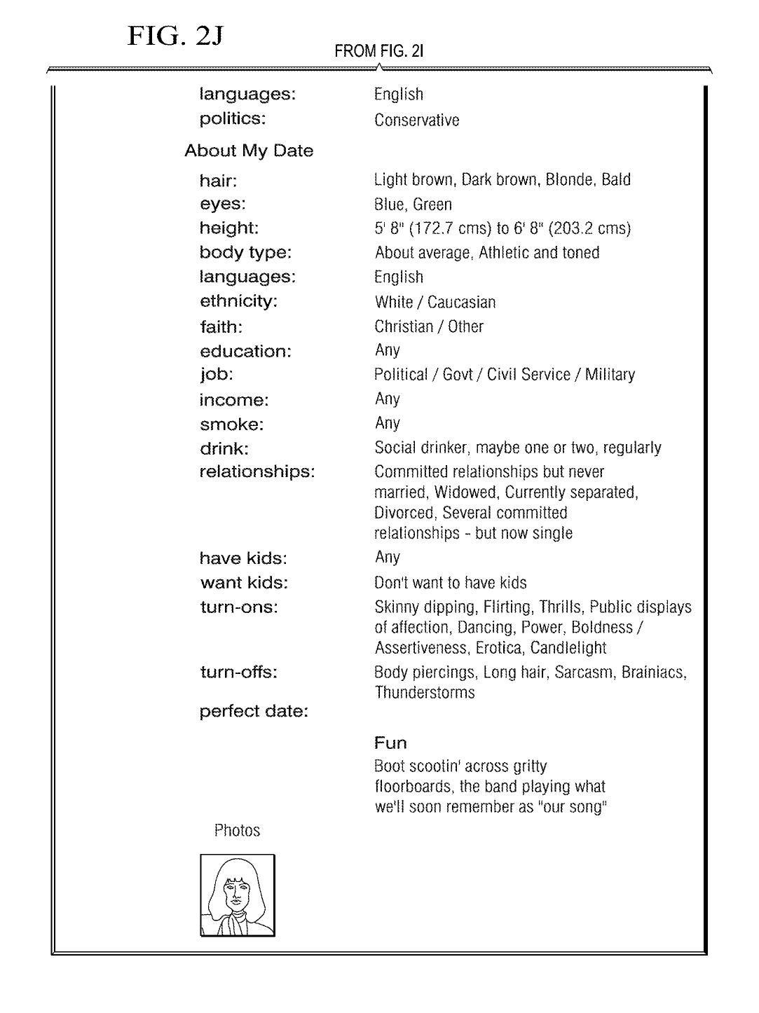

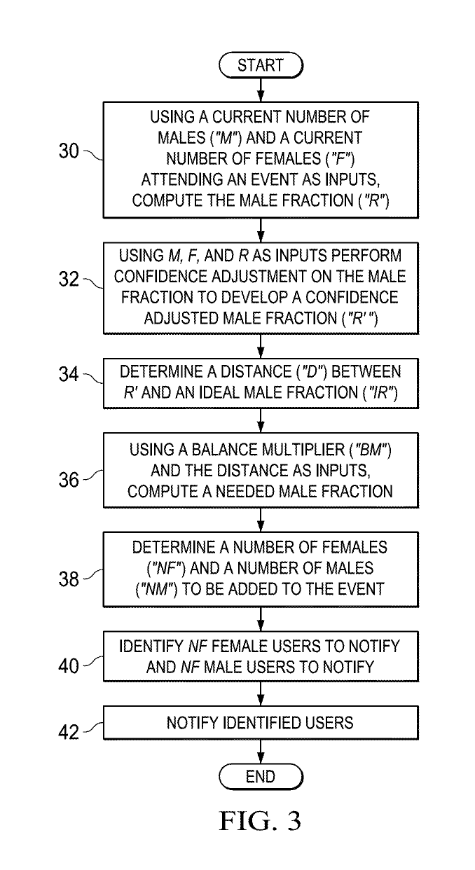

In one embodiment, the system 10 may include a feature referred to herein as an event notification feature. As will be described in detail below with reference to FIG. 3, one objective of the event notification feature is to optimize a number of women and a number of men attending an event associated with the system 10. For example, in one embodiment, it has been determined that it is desirable to have a particular ratio of men to women. The goal of the event notification feature is to send notifications to selected users, based on information contained in user profiles described above, in such a manner as to achieve and then maintain the desired male-to-female ratio for an event.

FIG. 3 is a flowchart illustrating logic implemented by an event notification feature in accordance with one embodiment. In one embodiment, the logic for implementing the event notification feature (potentially to be embodied in software) could be provided in web server 16. The event notification feature may be used in connection with the event promotion feature described in detail in related U.S. patent application Ser. No. 13/967,983 (Atty. Docket No. 76533.313), which is incorporated by reference hereinabove. In particular, the event notification feature described herein could be used to assist in adjusting the male-to-female ratio of users who have indicated that they will be attending or participating in an event being promoted using the event promotion feature. The event notification feature may be implemented once or numerous times with respect to an event to achieve a desired male-to-female ratio.

Referring to FIG. 3, in step 30, the event notification feature receives as inputs a number of males M and a number of females F who have indicated they plan to attend or participate in (or who have accepted an invitation to attend or participate in) an event associated with the system. In one embodiment, the event is a group event designed to facilitate interaction between men and women who share similarities (as identified in their respective personal profiles) in a group setting, which is potentially less intimidating than a one-on-one type of event, such as a blind date. For example, similarities among users may include age, geographic location (zip codes, mileage ranges, urban vs. rural, etc.), the type of activity involved in the event, any other demographic characteristic (income, previously divorced, religion, height/weight, education level, employment, how much a particular user has participated in such activities previously such that inexperience or experience could be used as a determinant, etc.) and a match quality (or match percentage) that characterizes how good of a match the user is relative to the event and/or relative to the other users who have already committed to participate in the event (“event participants”).

The event notification feature uses the inputs M and F to compute a current fraction of males R planning to attend the event, wherein R is calculated using the equation:

R=M/(M+F)

In step 32, the fraction R (which may also be expressed in terms of a percentage, rather than a fraction), number of males M and number of females F are used to perform a confidence adjustment to the male fraction R to develop a confidence adjusted male fraction R′ in accordance with the equation:

R′=R*(M+1)/M*(M+F)/(M+F+2)

A confidence adjustment enables selection of a sensible value for the fraction when little or no relevant data is available. In step 34, a distance D between R′ and an ideal fraction IR is calculated. In one embodiment, the ideal fraction is 0.5. The distance D is calculated in accordance with the equation:

D=IR−R′

In step 36, a needed male fraction NR is calculated using a balance multiplier BM. The balance multiplier dictates how strongly an imbalance in the male-to-female ratio is reacted to. The larger the BM, the more rapidly an imbalance is corrected. In order to avoid overcorrection, it is important to select an appropriate BM; one that is not too high or too low in view of the particular situation. The needed male fraction NR is calculated using the following equation:

NR=min(max(IR−D*BM),0.0),1.0)

The equation immediately above takes as inputs the observed difference between the ideal fraction IR and the current fraction, and computes the magnitude of the corrective action we need to take to make up that difference. The NR (needed fraction) represents the magnitude of our correction for the next set of users we invite to balance out the gender ratio in the event.

In step 38, the needed male fraction NR calculated in step 36, along with the total number of users needed for the event N are used to determine the number of males needed NM and the number of females needed NF. The number of males needed is calculated using the following equation;

NM=N*NR

The number of females needed is calculated using the following equation:

NF=N−NM

In step 40, NF female users of the system 10 and NM male users of the system 10 are identified to be notified of the event. This step may be performed using any number of techniques for selecting from among the various users using the profile information provided by those users. In one embodiment, some variation of a matching algorithm may be used to select the users relative to users that are already determined to be attending the event. For example, a matching algorithm may be used to select users who have similarities with other users who are attending the event; for example, users who are good personality matches with those who have already accepted an invitation to attend the event or who are within the same age range as those who have already accepted an invitation to attend the event. In another embodiment, users who have not been invited to an event recently may be prioritized to receive an invitation. In yet another embodiment, users whose profiles demonstrate a high likelihood that they will be interested in attending the event (e.g., users who live near the event venue) may be prioritized. It will be recognized that some combination of the foregoing, as well as other factors, may be used in selecting the particular users to invite to the event to provide the determined gender balance. In step 42, notifications are sent to the users identified in step 40. It will be recognized that notifications can be sent via instant messaging, text messaging, email messaging or by presenting a notification on the user's display while the user is accessing the system 10. The notification may include an electronic invitation that the user may accept by clicking on a designated link or graphical display element.

It should be noted that the process illustrated in FIG. 3 may be implemented periodically, as new users either accept, decline, or ignore the invitation extended in step 42, thereby affecting the group of event attendees and thus the respective male and female fractions. Additionally or alternatively, the process may be implemented in response to a trigger, such as a total number of event attendees reaching a certain threshold or failing to reach a certain threshold in a certain period of time. It is also possible that event invitations may be rescinded when a preferred total number of event attendees with the target male-to-female ratio is reached.

Although the present disclosure has been described in detail with reference to particular embodiments, it should be understood that various other changes, substitutions, and alterations may be made hereto without departing from the spirit and scope of the present disclosure. For example, although the present disclosure has been described with reference to a dating protocol, any service that deals with (or that leverages) profiles, photos, resumes, user information more generally, etc. could readily benefit from the present disclosure.

Moreover, although the present disclosure has been described with reference to a number of elements included within system 10, these elements may be rearranged or positioned in any appropriate manner to accommodate any suitable networking configurations. In addition, any of the elements of FIG. 1 may be provided as separate external components to system 10 or to each other where appropriate.

It should also be noted that any of the question portions of the platform can leverage any type of format. Thus, in any aspect of the online dating process described herein, such as establishing a personality profile, for example, any suitable question format can be employed. Example formats include a Yes/No format, a multiple choice question format, a short answer format, a true/false format, etc. Other formats can readily be used in order to achieve the desired responses and solicit the appropriate data.

Note that in certain example implementations, the matching functions outlined herein, such as those carried out by web server 16 and/or provided as an application for an endpoint being operated by an end user (e.g., a mobile application for an iPhone™), may be implemented by logic encoded in one or more non-transitory, tangible media (e.g., embedded logic provided in an application specific integrated circuit (“ASIC”), digital signal processor (“DSP”) instructions, software (potentially inclusive of object code and source code) to be executed by a processor, or other similar machine, etc.). In some of these instances, a memory, as shown in FIG. 1, can store data used for the operations described herein. This includes the memory being able to store software, logic, code, or processor instructions that are executed to carry out the activities described in this Specification.

A processor can execute any type of instructions associated with the data to achieve the operations detailed herein in this Specification. In one example, the processor, as shown in FIG. 1, could transform an element or an article (e.g., data) from one state or thing to another state or thing. In another example, the activities outlined herein may be implemented with fixed logic or programmable logic (e.g., software/computer instructions executed by a processor) and the elements identified herein could be some type of a programmable processor, programmable digital logic (e.g., a field programmable gate array (“FPGA”), an erasable programmable read only memory (“EPROM”), an electrically erasable programmable ROM (“EEPROM”)) or an ASIC that includes digital logic, software, code, electronic instructions, or any suitable combination thereof.

These devices illustrated herein may maintain information in any suitable memory (random access memory (“RAM”), ROM, EPROM, EEPROM, ASIC, etc.), software, hardware, or in any other suitable component, device, element, or object where appropriate and based on particular needs. Any of the memory items discussed herein should be construed as being encompassed within the broad term “memory.” Similarly, any of the potential processing elements, modules, and machines described in this Specification should be construed as being encompassed within the broad term “processor.” Each of the network elements can also include suitable interfaces for receiving, transmitting, and/or otherwise communicating data or information in a network environment.

Note that with the example provided above, as well as numerous other examples provided herein, interaction may be described in terms of more than one network element. However, this has been done for purposes of clarity and example only. In certain cases, it may be easier to describe one or more of the functionalities of a given set of flows by only referencing a limited number of network elements. It should be appreciated that system 10 (and its teachings) are readily scalable and can accommodate a large number of components, as well as more complicated/sophisticated arrangements and configurations. Accordingly, the examples provided should not limit the scope or inhibit the broad teachings of system 10 as potentially applied to a myriad of other architectures.

It is also important to note that the steps in the preceding flow diagrams illustrate only some of the possible signaling scenarios and patterns that may be executed by, or within, system 10. Some of these steps may be deleted or removed where appropriate, or these steps may be modified or changed considerably without departing from the scope of the present disclosure. In addition, a number of these operations have been described as being executed concurrently with, or in parallel to, one or more additional operations. However, the timing of these operations may be altered considerably. The preceding operational flows have been offered for purposes of example and discussion. Substantial flexibility is provided by system 10 in that any suitable arrangements, chronologies, configurations, and timing mechanisms may be provided without departing from the teachings of the present disclosure. Although the present disclosure has been described in detail with reference to particular arrangements and configurations, these example configurations and arrangements may be changed significantly without departing from the scope of the present disclosure.

Numerous other changes, substitutions, variations, alterations, and modifications may be ascertained to one skilled in the art and it is intended that the present disclosure encompass all such changes, substitutions, variations, alterations, and modifications as falling within the scope of the appended claims. In order to assist the United States Patent and Trademark Office (USPTO) and, additionally, any readers of any patent issued on this application in interpreting the claims appended hereto, Applicant wishes to note that the Applicant: (a) does not intend any of the appended claims to invoke paragraph six (6) of 35 U.S.C. section 112 as it exists on the date of the filing hereof unless the words “means for” or “step for” are specifically used in the particular claims; and (b) does not intend, by any statement in the specification, to limit this disclosure in any way that is not otherwise reflected in the appended claims.

What is claimed is:

1. A method, comprising:
determining a first number of users who have indicated an intention to attend an event;
determining what fraction of the first number of users is a particular gender;
using the determined fraction and an ideal fraction of the particular gender for the event to determine an additional number of males or an additional number of females to be invited to attend the event; and
identifying, from a pool of users, additional males or additional females.

2. The method of claim 1 further comprising inviting the identified additional females or additional males to the event.

3. The method of claim 2, wherein the inviting comprises sending an email comprising an invitation to the event to the identified additional males and additional females.

4. The method of claim 2, wherein the inviting comprises displaying information concerning the event to the identified additional males and females.

5. The method of claim 1, wherein the identifying comprises identifying users from the pool of users whose profile attributes or event invitation history indicate a likelihood that they will accept an invitation to attend the event.

6. The method of claim 1, wherein the identifying comprises identifying users from the pool of users that share similar profile attributes with the first number of users.

7. The method of claim 1, wherein the using comprises using a balance multiplier to control how strongly an imbalance in a male-to-female ratio of the first number of users would be reacted to.

8. One or more non-transitory tangible media that includes code for execution and when executed by a processor is operable to perform operations comprising:
determining a first number of users who have indicated an intention to attend an event;
determining what fraction of the first number of users is a particular gender;
using the determined fraction and an ideal fraction of the particular gender for the event to determine an additional number of males or an additional number of females to be invited to attend the event; and
identifying, from a pool of users, additional males or additional females.

9. The media of claim 8, the operations further comprising:
inviting the identified additional females or additional males to the event.

10. The media of claim 9, wherein the inviting comprises sending an email comprising an invitation to the event to the identified additional males or additional females.

11. The media of claim 9, wherein the inviting comprises displaying information concerning the event to the identified additional males or additional females.

12. The media of claim 8, wherein the identifying comprises identifying users from the pool of users whose profile attributes or event invitation history indicate a likelihood that they will accept an invitation to attend the event.

13. The media of claim 9, wherein the identifying comprises identifying users from the pool of users that share similar profile attributes with the first number of users.

16. The media of claim 9, the operations further comprising:
using a balance multiplier to control how strongly an imbalance in a male-to-female ratio of the first number of users would be reacted to.

17. A server, comprising:
a processor and a memory, wherein the server is configured to:
determine a first number of users who have indicated an intention to attend an event;
determine what fraction of the first number of users is a particular gender;
use the determined fraction and an ideal fraction of the particular gender for the event to determine an additional number of males or an additional number of females to be invited to attend the event; and
identify, from a pool of users, additional males or additional females.

18. The server of claim 17, wherein the server is further configured to invite the identified additional females or additional males to the event.

19. The server of claim 18, wherein the inviting comprises sending an email comprising an invitation to the event to the identified additional males or additional females.

20. The server of claim 18, wherein the inviting comprises displaying information concerning the event to the identified additional males or additional females.
